(19) United States
(12) Patent Application Publication
(10) Pub. No.: US 2014/0289351 A1
(43) Pub. Date: Sep. 25, 2014

(54) METHOD AND DEVICE FOR SENDING MESSAGE TO GROUP USER(S) THROUGH MICROBLOG

(71) Applicants: Yuteng Chen, Shenzhen City (CN); Mingming He, Shenzhen City (CN); Mingzhong Ji, Shenzhen City (CN); Zhihao Zheng, Shenzhen City (CN); Zhu Liang, Shenzhen City (CN); Xitong Huang, Shenzhen City (CN)

(72) Inventors: Yuteng Chen, Shenzhen City (CN); Mingming He, Shenzhen City (CN); Mingzhong Ji, Shenzhen City (CN); Zhihao Zheng, Shenzhen City (CN); Zhu Liang, Shenzhen City (CN); Xitong Huang, Shenzhen City (CN)

(73) Assignee: TENCENT TECHNOLOGY (SHENZHEN) COMPANY LIMITED, Shenzhen City (CN)

(21) Appl. No.: 14/354,639

(22) PCT Filed: Jun. 1, 2012
(86) PCT No.: PCT/CN2012/076399

§ 371 Date: Apr. 28, 2014

(30) Foreign Application Priority Data
Oct. 28, 2011 (CN) 201110335081.7

(51) Int. Cl. H04L 12/58

(52) U.S. Cl. CPC H04L 51/04
USPC 709/206

(57) ABSTRACT

The present invention discloses a method and device for sending a message to group user(s) through microblog, which can simply and rapidly send the message to the group user(s) through a symbol @. In the present invention, group(s) that a user has joined is inquired for the user when the user sends a message, and the message is able to be sent to the group user(s) in the manner of “@group”, instead of being sent to each group user in the manner of “@user nickname” for many times, which improves the efficiency of sending messages by group, and brings convenience to the user.

### FIELD OF INVENTION

The present invention relates to a technique of sending a message over a network, and in particular, to a method and device for sending a message to group user(s) through microblog.

### BACKGROUND

A symbol “@” has special meaning in current microblog or other textual network interaction systems. For example, in microblog, it represents the function of “talk to somebody”, which strengthens the directivity of posting through microblog. When you post a message with “@user's nickname”, which means herein to “mention somebody” and “talk to somebody”, a notification of a message mentioning him will appear on the page of the microblog user who has been mentioned, and he can see your talk in a certain way and make a reply, achieving approximately a one-to-one conversation in a broadcast scene.

In current network products, such as blog, microblog, online community, instant messaging tool, etc., in order to promote exchanges between users, the users are usually categorized, so that the exchanges between the users having some same hobby or some common characteristic will be easier. For example, a community in blog, a group in an instant messaging tool and so on, which are collectively referred to as a “group” in the present invention. The “group” can be interpreted as a set of user(s) comprising one or more users. In general, in order to identify a group, a group identifier and a group name are assigned to the group.

At present, in a system similar to microblog, sending a message by @ can only target a single person to achieve a virtual one-to-one conversation, in which only the nickname of a single user is allowed to be added behind the symbol @; clicking “@user's nickname” in a message posted by a person can directly lead to the page of this person; or all messages mentioning this person can be displayed through “@user's nickname”

In a network product with the group characteristic, when a message is sent to all user(s) in a group through the symbol @, many symbols @ are required and the nickname of each user in the group need to be added, which is very cumbersome and inefficient.

### SUMMARY OF THE INVENTION

In view of the above, the embodiments of the present invention provide a method and device for sending a message to group user(s) through microblog, which can simply and rapidly send the message to the group user(s) through a symbol @.

According to one aspect of the present invention, the embodiments of the present invention provide a method for sending a message to group user(s) through microblog, which comprises:
a service end parsing a received message, and when finding that the message contains “@group identifier”, acquiring the group identifier behind the “@”;
the service end acquiring a list of group member user(s) by the group identifier, and pushing the message to each group member user in the list of group member user(s).

According to another aspect of the present invention, the embodiments of the present invention also provide a device for sending a message to group user(s) through microblog, which comprises:
an acquiring unit, for receiving and parsing a message and acquiring a group identifier indicated by “@group identifier” from the message;
a push unit, for acquiring a list of group member user(s) by the group identifier and pushing the message to each group member user in the list of group member user(s).

According to another aspect of the present invention, the embodiments of the present invention also provide a computer program product containing program instructions which, when being executed on a processor, instruct the processor to perform the aforesaid method steps.

According to yet another aspect of the present invention, the embodiments of the present invention also provide a storage medium carrying the aforesaid computer program.

With the method and device provided by the present invention, a user is enable to send a message to the group user(s) in the manner of “@group” when the user sends the message, instead of sending the message to each group user in the manner of “@user nickname” for many times, which improves the efficiency of sending messages by group, brings convenience to the user, and can be implemented simply and rapidly.

### BRIEF DESCRIPTION OF THE DRAWINGS

FIG. 1 is a flowchart of a method for sending a message to group user(s) provided by an embodiment of the present invention;

FIG. 2 is a structure diagram of a device for sending a message to group user(s) provided by an embodiment of the present invention.

### DETAILED DESCRIPTION

To render the targets, technical solutions and advantages of the present invention clearer, a further detailed description of the present invention will be given in the following by illustrating the embodiments and referring to the accompanying drawings.

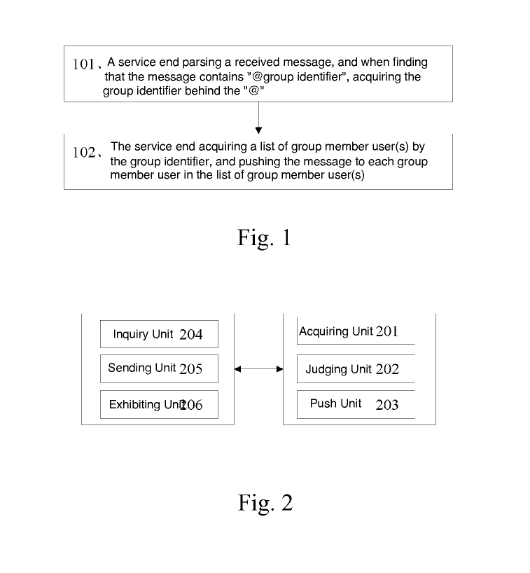

FIG. 1 is a flowchart of a method for sending a message to group user(s) provided by an embodiment of the present invention, with the method comprising:

Step 101: A service end parsing a received message, and when finding that the message contains “@group identifier”, acquiring the group identifier behind the “@”.

In embodiments of the present invention, when a terminal end broadcasts a message or sends a message to other user(s), the message firstly needs to be sent to the service end, which will parse the message and perform corresponding processing.

Taking a microblog system as example, when a microblog user broadcasts a message, the message firstly needs to be sent to the microblog service end, and if the microblog user desires to inform all user(s) in a certain group of the message mentioning them, the service end can be notified by containing “@group identifier” in the message; after receiving the message, the service end parses the content of the message, and when finding that the message contains the “@group identifier”, it acquires the group identifier behind the “@”; and then, the service end acquires a list of the user(s) of the group by the group identifier, and indicates to each group member user that the message mentions the group member user.

Step 102: The service end acquiring a list of group member user(s) by the group identifier, and pushing the message to each group member user in the list of group member user(s).

Preferably, the premise for the service end being able to acquire the list of group member user(s) by the group identifier is that: the user sending the message is a group member user of the group. Therefore, if the service end detects that the user sending the message is not a group member user in the group indicated by the group identifier, the service end may perform no processing, so as to avoid a non-group member user disturbing the group member user(s); if the service end confirms that the user sending the message is a group member user in the group indicated by the group identifier through a detection, the service end will acquire the list of group member user(s) by the group identifier, and push the message to each group member user.

Preferably, the group member user sending the message is removed from the list of group member user(s).

Step 103: The group member user(s) in the list of group member user(s) acquiring and displaying the message.

Taking a microblog system as example, after a group member user A sends a message to other group member user(s) in his own group in the manner of @, the microblog service end will push the message to the member user(s) other than the group member user A in the group. Any other member user in the group, after logging onto his microblog page, can view the message through a page with the latest messages, or a “message with @me” page, or a “@group name” page. For example, the group name corresponding to the group identifier 123456 is “classmate group”, and thus, a hyperlink similar to “messages with @classmate group” will be displayed on the homepage of the microblog user, and when the user clicks this hyperlink, all messages mentioning the “classmate group” will be displayed.

Preferably, for convenience of a user of a terminal end sending a message to group user(s), before the terminal end sends the message to the service end, it will firstly inquire the service end about a list of group(s) which the user sending the message has joined, and indicate to the user in a certain way for the user's selection. According to the list of the group(s), the user sending the message will indicate in the message the group to be mentioned by the message, so as to avoid the user searching for the group identifier of the group he has joined every time if he forgets the group identifier. Wherein, the indication means include but are not limited to the following: displaying as a list in a message input window, wherein when the user clicks a group identifier in the list, “@group identifier” is automatically added into the message input box; or when the user inputs the symbol “@”, displaying the group identifies of all group(s) that the user has joined in a floating window of a pull-down list, so as to facilitate the user's selection.

Preferably, a same message can include one or more pieces of “@group identifier”, wherein multiple pieces of “@group identifier” can be separated from one another by a separator, and the service end processes all pieces of “@group identifier” one by one. The group identifier according to the present invention can be an identifier that can uniquely identify a group, such as group number, group name, etc.

In this embodiment, the service end can be a server; and the microblog service end can be a microblog server.

Examples of the message of the present invention are as follows.

Example 1 of the message: “Hello, everyone! @123456”;

wherein the application scene of this embodiment is that a certain group user of a group with a group identifier 123456 says hello to other group user(s) of the group.

Example 2 of the message: “who is going to the activity on Sunday @classmate”;

wherein the application scene of this embodiment is that a certain group user of a group with a group name “classmate” asks in the group “who is going to the activity on Sunday?”

Example 3 of the message: “recommend a good book XXXX to all of you @123456, @classmate”

wherein the application scene of this embodiment is that a certain group member user who belongs to both the group with the group identifier “123456” and the group with the group name “classmate” recommends a good book to other group member user(s) of either of the two groups.

FIG. 2 is a structure diagram of a device for sending a message to group user(s) provided by the embodiments of the present invention. The device comprises two parts: a sender and a receiver. In the present invention, a terminal end serves as the sender, and a service end services as the receiver. The major improvement achieved by the present invention lies in the receiver. Therefore, the device at least comprises:
an acquiring unit 201, for receiving and parsing a message, and acquiring a group identifier indicated by “@group identifier” from the message;
a push unit 203, for acquiring a list of group member user(s) by the group identifier, and pushing the message to each group member user in the list of group member user(s).

The acquiring unit 201 and the push unit 203 are located in the receiver.

Preferably, the device also comprises:
a judging unit 202, for judging whether the user sending the message is a group member user of the group indicated by the group identifier, and if the user sending the message is not a group member user of the group indicated by the group identifier, instructing the push unit to perform no push processing, otherwise instructing the push unit to perform the push processing. The judging unit 202 is located in the receiver.

Preferably, the device 200 also comprises:
an inquiry unit 204, for inquiring a list of group(s) that the user sending the message has joined;
a sending unit 205, for inputting the message and indicating the group to be mentioned by the message in the manner of “@group identifier” in the message according to the list of the group(s);
an exhibiting unit 206, for exhibiting the message to the group member user(s) in the list of group member user(s) through a page with the latest messages, or a “message with @me” page, or a “@group name” page.

The inquiry unit 204, the sending unit 205, and the exhibiting unit 206 are located in the sender.

Wherein, the message sent by the sending unit 205 can include one or more pieces of “@group identifier”.

What are stated above are only the preferred embodiments of the present invention, and are not intended to restrict the protection scope of the present invention.

What is claimed is:

1. A method for sending a message to group user(s) through microblog, comprising:
a service end parsing a received message, and when finding that the message contains “@group identifier”, acquiring the group identifier behind the “@”;
the service end acquiring a list of group member user(s) by the group identifier, and pushing the message to each group member user in the list of group member user(s).

2. The method of claim 1, wherein each group member user in the list of group member user(s) acquires and displays the message through a page with the latest messages, or a “message with @me” page, or a “@group name” page.

3. The method of claim 1, wherein before the service end pushes the message to each group member user in the list of group member user(s), the method also comprises: the service end detecting whether a user sending the message is a group member user of a group indicated by the group identifier;
if the user sending the message is a group member user of the group indicated by the group identifier, the service end will perform a processing of pushing the message;
if the user sending the message is not a group member user of the group indicated by the group identifier, the service end will not perform the processing of pushing the message.

4. The method of claim 1, wherein the method also comprises:
before a terminal end sends the message, it inquiring the service end about a list of group(s) that the user sending the message has joined, and the user sending the message indicating in the message a group to be mentioned by the message according to the list of the group(s).

5. The method of claim 1, wherein one or more groups to be mentioned by the message are indicated in a same message by one or more pieces of “@group identifier”.

6. A device for sending a message to group user(s) through microblog, comprising:
an acquiring unit, for receiving and parsing a message and acquiring a group identifier indicated by “@group identifier” from the message;
a push unit, for acquiring a list of group member user(s) by the group identifier and pushing the message to each group member user in the list of group member user(s).

7. The device of claim 6, wherein the device also comprises:
an inquiry unit, for inquiring a list of group(s) that the user sending the message has joined;
a sending unit, for inputting the message and indicating the group to be mentioned by the message in the manner of “@group identifier” in the message according to the list of the group(s);
an exhibiting unit, for exhibiting the message to the group member user(s) in the list of group member user(s) through a page with the latest messages, or a “message with @me” page, or a “@group name” page.

8. The device of claim 6 or claim 7, wherein the device also comprises:
a judging unit, for judging whether the user sending the message is a group member user of the group indicated by the group identifier, and if the user sending the message is not a group member user of the group indicated by the group identifier, instructing the push unit to perform no push processing, otherwise instructing the push unit to perform the push processing.

9. The device of claim 7, wherein the message sent by the sending unit includes one or more pieces of “@group identifier”.

10. A computer program product, containing program instructions which, when being executed on a processor, instruct the processor to perform the steps of the method of any of claims 1-5.

11. A storage medium, carrying a computer program of claim 10.
